(19) United States
(12) Patent Application Publication
(10) Pub. No.: US 2026/0118590 A1
(43) Pub. Date: Apr. 30, 2026

(54) SEMICONDUCTOR STRUCTURE AND METHOD OF FABRICATING THE SAME

(71) Applicant: Taiwan Semiconductor Manufacturing Company, Ltd., Hsinchu (TW)

(72) Inventor: Feng-Wei KUO, Hsinchu (TW)

(73) Assignee: Taiwan Semiconductor Manufacturing Company, Ltd., Hsinchu (TW)

(21) Appl. No.: 18/931,377

(22) Filed: Oct. 30, 2024

(51) Int. Cl. G02B 6/34

(52) U.S. Cl. CPC G02B 6/34

(57) ABSTRACT

A semiconductor structure includes a semiconductor layer. The semiconductor structure includes grating coupler disposed on the semiconductor layer. The grating coupler includes a plurality of grating lines. Each of the grating lines extends along a curve that conforms to a segment of an ellipse, where the ellipse is defined by a radius R1 and a radius R2 less than the radius R1. The semiconductor structure further includes a waveguide disposed on the semiconductor layer. The waveguide is adjacent to the grating coupler along a lateral direction.

### BACKGROUND

Silicon photonic technologies are emerging as important roles for high-speed optical data communication. For instance, optical transceiver modules including high-speed phase modulators, grating couplers and waveguides are used in high-speed optical communication systems. The optical transceiver modules comply with various international standard specifications at communication speeds ranging up to more than 100 Gbps. The performance of the optical transceiver modules is determined by coupling efficiency of the grating couplers in the optical transceiver modules. Although structures of existing grating couplers used for optical transceiver modules have been generally adequate, they are not entirely satisfactory in all aspects.

### BRIEF DESCRIPTION OF FIGURES

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of an example optical transceiver, in accordance with some embodiments of the present disclosure.

FIG. 2 is a top view of an example photonic die having a grating coupler connected to a waveguide, in accordance with some embodiments of the present disclosure.

FIG. 3 is a schematic illustration of an apparatus including an optical fiber and a cross-sectional view of an embodiment of the example photonic die taken along line AA’ of FIG. 2, in accordance with some embodiments of the present disclosure.

FIG. 4 is a schematic illustration of a beam spot provided by an optical fiber, in accordance with some embodiments of the present disclosure.

FIG. 5 is a cross-sectional view of an embodiment of the example photonic die taken along line AA’ of FIG. 2, in accordance with some embodiments of the present disclosure.

FIGS. 6, 7, 8 are each a cross-sectional view of a portion of the example photonic die of FIG. 5, in accordance with some embodiments of the present disclosure.

FIG. 9 is a flowchart of an example method of fabricating a semiconductor structure, such as the example photonic die of FIGS. 2 and 3, in accordance with some embodiments of the present disclosure.

FIGS. 10, 11, 12, 13, 14, 15, 16, 17, 18, 19, 20, and 21 are cross-sectional views of a semiconductor structure during intermediate stages of the example method of FIG. 9, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

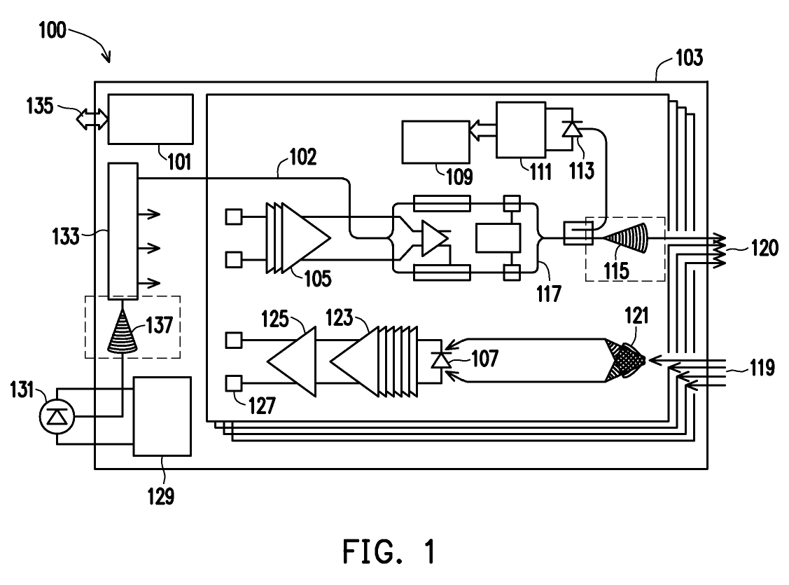

FIG. 1 illustrates a block diagram of an example optical transceiver 100. The optical transceiver 100 may include optical modulators 117, monitor photodiode 113, and grating couplers 115 and 121. The optical transceiver 100 may also include electrical devices and circuits including amplifiers 105 and 123, an analog to digital converter circuit 111, a digital control circuit 101, a photodiode(s) 107 and control section 109. The amplifiers 105 and 123 may include transimpedance and limiting amplifiers (TIA/LAs), for example. In some embodiments, the optical transceiver 100 further includes a photonic die 103 with a laser assembly. In some embodiments, the laser assembly includes one or more laser 131, lenses, rotators for directing one or more continuous-wave (CW) optical signals, and one or more laser driver 129.

In further embodiments, the optical transceiver 100 includes an input grating coupler 137 that is configured to receive an optical signal from the laser 131 and an optical splitter 133 that is configured to split the optical signal into four roughly equal power optical signals. In various embodiments, the split power signals are transmitted from the optical splitter 133 to the optical modulators 117 through optical waveguides. In some embodiments, the optical splitter 133 is coupled to the input grating coupler 137 and at least four output waveguides 102. In some embodiments, the optical splitter 133 includes a low-loss Y-junction power splitter. In some embodiments, the input grating coupler 137 includes a single-polarization grating coupler (SPGC). In some embodiments, the SPGC is a one-dimensional (1D) grating coupler.

In some embodiments, the optical modulators 117 include Mach-Zehnder or ring modulators, for example, and enable the modulation of the CW laser input signal. The optical modulators 117 may also include high-speed and low-speed phase modulation sections and are controlled by the control sections 109. In some embodiments, at least one of outputs of each of the optical modulators 117 is optically coupled to an optical output 120 such as an optical fiber via the grating coupler 115. In some embodiments, the grating coupler 115 includes an SPGC. The other outputs of the optical modulators 117 may be optically coupled to the monitor photodiode 113 that is configured to provide a feedback path from the output of the optical modulators 117 to the control section 109.

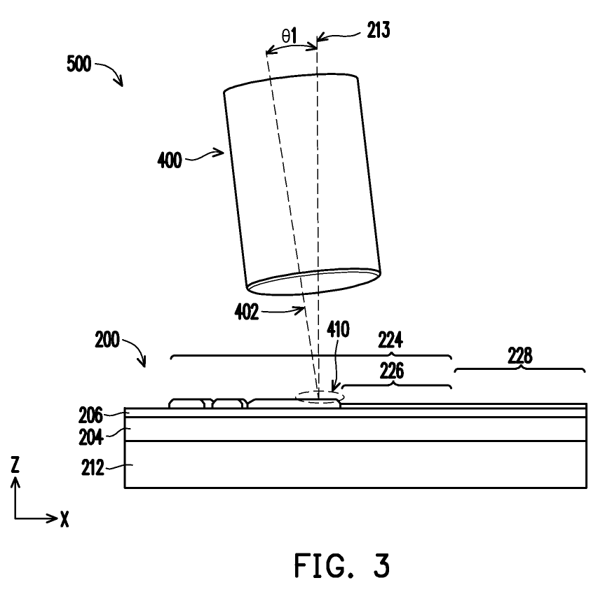

Furthermore, the optical transceiver 100 may also utilize a grating coupler 121 for receiving optical signals from an optical fiber 400 (see FIG. 3) or an array of optical fibers 400. In the present embodiments, the grating coupler 121 includes a polarization splitting grating coupler (PSGC) that utilizes two waveguides (or output waveguides) to transmit received optical signals to the photodiode(s) 107.

In some embodiments, the optical transceiver 100 employs the photodiode(s) 107, which may be implemented with epitaxial germanium (Ge)/silicon germanium (SiGe) films deposited directly on silicon (Si). In some embodiments, the photodiode(s) 107 may include high-speed heterojunction phototransistors, for example, and may include Ge in the collector and base regions for absorption in the 1200 nm to 1600 nm wavelength range (e.g., in the range of 1310 nm to 1550 nm), and may be integrated on a complementary metal-oxide-semiconductor (CMOS) silicon-on-insulator (SOI) wafer. The photodiode(s) 107 may be configured to convert optical signals received from the grating coupler 121 into electrical signals that are communicated to a receiver (Rx) 123 which may be configured to combine data streams, and demultiplex the received optical signals. Furthermore, the received optical signals may be amplified by a transimpedance amplifier 125, for example, and subsequently communicated to a small form-factor pluggable (SFP) interface circuitry 127. In some embodiments, the optical transceiver 100 also includes a digital control circuit 101 coupled to a serial interface 135 and configured to communicate received optical data through the serial interface 135.

As shown in FIG. 1, the grating couplers 115 and 137 of the optical transceiver 100 enable coupling of light into and out of the integrated circuit comprising the optical transceiver 100. In some embodiments, the geometry parameters of the grating couplers 115 and 137 may be parametrized during the routing and layout of the photonically-enabled integrated circuit and optimized based on the performance index.

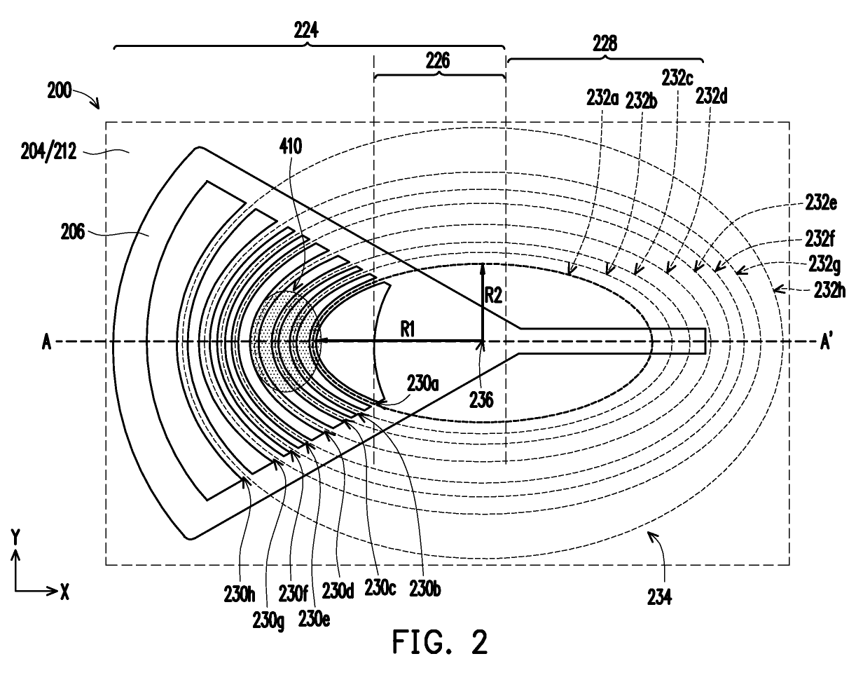

FIG. 2 illustrates a top view of a photonic die 200, or a portion thereof, according to some embodiments of the present disclosure. The photonic die 200 includes at least a grating coupler 224 coupled to a waveguide 228. The grating coupler 114 includes a tapered structure 226 (also referred to as a tapered region 226) that is disposed adjacent to the waveguide 228. A portion of the grating coupler 224 (e.g., grating lines 230 described below) is configured to receive and modulate optical input from an optical fiber (e.g., optical fiber 400 (or an array thereof); see FIG. 3), and the modulated optical input is subsequently transmitted to the waveguide 228 through the tapered structure 226. In the depicted embodiments, the grating coupler 224 and the waveguide 228 are arranged adjacent to one another along a first lateral direction (e.g., the X axis). In some embodiments, the tapered structure 226 is disposed immediately adjacent to the waveguide 228 along the first lateral direction. The grating coupler 224 and the waveguide 228 are disposed over (or in) a semiconductor layer 206. In this regard, the semiconductor layer 206 is alternatively referred to as a device layer 206 (or photonic device layer 206).

Referring to FIG. 3, which is a cross-sectional view of the photonic die 200 along line AA’ of FIG. 2, the semiconductor layer 206 is formed over (or provided on) a dielectric layer 204, which overlays a semiconductor substrate 212. In some embodiments, the photonic die 200 corresponds to a portion of the optical transceiver 100 as depicted within each dashed enclosure in FIG. 1. For example, the grating coupler 224 may correspond to the grating coupler 115 or 137 and the waveguide 228 correspond to the waveguide 102. The tapered structure 226 extends between the portion of the grating coupler 224 that receives and modulates optical input (e.g., the grating lines 230 described below) and the waveguide 228.

In the present embodiments, referring back to FIG. 2, the grating coupler 224 is a one-dimensional (1D) grating coupler, such as a single-polarization grating coupler. The grating coupler 224 includes a set of grating lines 230a, 230b, 230c, 230d, 230e, 230f, 230g, and 230h (collectively referred to as the grating lines 230 hereafter). The grating lines 230 are concentrically arranged in a pattern and spaced apart from one another along the first lateral direction. As will be described in detail below, dimensions may vary between the grating lines 230 along the first lateral direction. It is noted that, although a set of eight grating lines 230 are depicted in FIG. 2, embodiments of the photonic die 200 described in the present disclosure are not limited as such and may include, for example, more or less grating lines 230.

In the present embodiments, each of the grating lines 230a-230h extends along a curve that conforms to a segment of a respective ellipse 232a-232h(or elliptical shapes 232a-232h; collectively referred to as ellipses 232 hereafter). For example, the grating line 230a extends along a curve that conforms to a segment of the ellipse 232a; the grating line 230b extends along a curve that conforms to a segment of the ellipse 232b; the grating line 230c extends along a curve that conforms to a segment of the ellipse 232c; the grating line 230d extends along a curve that conforms to a segment of the ellipse 232d; the grating line 230e extends along a curve that conforms to a segment of the ellipse 232e; the grating line 230f extends along a curve that conforms to a segment of the ellipse 232f; the grating line 230g extends along a curve that conforms to a segment of the ellipse 232g; and the grating line 230h extends along a curve that conforms to a segment of the ellipse 232h. The ellipses 232 are arranged in a concentric pattern 234, where a center 236 of the concentric pattern 234 (i.e., a center of each of the ellipses 232) lies on an axis that extends along the first lateral direction. In some embodiments, the center 236 is disposed in the tapered structure 226. It is noted that the ellipses 232 are not physically present in the photonic die 200 but are rather guides configured to describe shapes and dimensions of their corresponding grating lines 230.

Still referring to FIG. 2, each of the ellipses 232 is defined by a major radius R1 and a minor radius R2. The major radius R1 extends along the first lateral direction and the minor radius R2 extends along a second lateral direction (e.g., the Y axis) perpendicular to the first lateral direction. The major radius R1 is greater than the minor radius R2 in magnitude for each of the ellipses 232 such that a ratio S of the major radius R1 to the minor radius R2 (S = R1/R2) is greater than 1. In this regard, each of the ellipses 232 is elongated along the first lateral direction relative to the second lateral direction. In the present embodiments, the major radius R1 and the minor radius R2 both decrease from the ellipse 232h towards the ellipse 232a along the first lateral direction. In other words, the major radius R1 and the minor radius R2 of the ellipse 232h are each greater than the corresponding dimensions of the ellipse 232g, which are greater than the corresponding dimensions of the ellipse 232f, and so on. In some embodiments, the ratio S remains substantially constant within the concentric pattern 234. In some embodiments, the ratio S varies between the ellipses 232 along the first lateral direction. In some non-limiting examples, the major radius R1 and the minor radius R2 each range from about 10 nm to about 100 nm. In some non-limiting examples, the ratio S ranges from about 1.5 to about 2.6 corresponding to certain optical input conditions described in detail below.

FIG. 3 illustrates an apparatus 500, or a portion thereof, according to some embodiments of the present disclosure. The apparatus 500 includes at least an embodiment of the photonic die 200 as shown in a cross-sectional view taken along line AA’ of FIG. 2. The apparatus 500 further includes an optical fiber 400 disposed over the photonic die 200 and configured to provide optical input to the photonic die 200. In some embodiments, an incident light emitted through a fiber core 402 of the optical fiber 400 is applied at an incident angle θ1. In the present embodiments, the incident angle θ1 is defined as an angle between an axis along which the fiber core 402 extends and a normal 213 of the photonic die 200 (i.e., a normal of a top surface of the semiconductor substrate 212 or the semiconductor layer 206). In some non-limiting examples, the incident angle θ1 may range from about 0° to about 15°, such as from about 5° to about 15°. In some embodiments, the optical fiber 400 is a single-mode fiber (SMF).

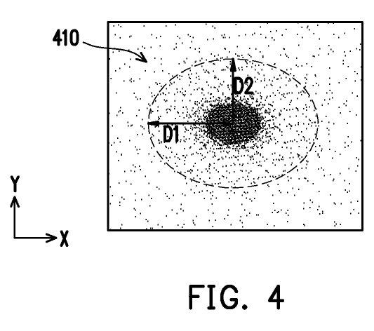

As shown in FIGS. 3 and 4, the fiber core 402 illuminates the grating coupler 224 and forms a beam spot 410 over the grating coupler 224. The size of the beam spot 410 is related to an effective area of the fiber core 402, which is proportional to an optical power of the fiber core 402 upon illumination. The effective area of the fiber core 402 can be further defined by a mode field diameter (MFD). For example, referring to FIG. 4, the beam spot 410 provided to the grating coupler has a first radius D1 extending along the first lateral direction and a second radius D2 extending along the second lateral direction. In various embodiments, the radii D1 and D2 vary based on the incident angle θ1 defined herein. For embodiments in which the incident angle θ1 is about 0°(i.e., the fiber core 402 is substantially parallel to the normal 213 of the photonic die 200), the beam spot 410 is characterized by a substantially circular shape (not depicted herein), with the first radius D1 being substantially the same as the second radius D2. In this regard, a ratio Q of D1 to D2 (Q = D1/D2) is about 1 and the beam spot 410 is said to have equal MFDs along the first lateral direction and the second lateral direction.

In existing technologies, however, the incident angle θ1 is generally tuned to be greater than 0° (i.e., the fiber core 402 is angled with respect to the normal 213 of the photonic die 200), such as at about 5° to about 15°, in order to lower the reflection of the incident light off the grating coupler 224, thereby increasing the coupling efficiency of the photonic die 200. As such, referring to FIG. 4, the beam spot 410 illuminated onto the grating coupler 224 does not have a circular shape but is characterized by a substantially elliptical shape having the first radius D1 being greater than the second radius D2. Consequently, the ratio Q is greater than 1, and the beam spot 410 is said to have unequal MFDs along the first lateral direction and the second lateral direction. The radii D1 and D2 may be alternatively referred to as the major radius and the minor radius, respectively, of the beam spot 410.

The present disclosure provides photonic dies having a grating coupler with a geometry that more closely matches the geometry of a beam spot illuminating the grating coupler to enhance the coupling efficiency and thus the overall performance of the photonic device. For example, in comparison to existing technologies, the geometry of the grating coupler provided herein increases the peak loss of the grating coupler from about 75% to about 81%, for example. In the present embodiments, the geometry (e.g., the shape and dimensions) of the grating lines 230 of the grating coupler 224 are configured such that a curvature of each of the grating lines 230 at least partially overlaps the curvature of the beam spot 410 at a given incident angle θ1. In other words, the major radius R1 and the minor radius R2 for each of the ellipses 232 are configured such that a curvature of each corresponding grating line 230 matches with or otherwise traverses the curvature of the beam spot 410 generated at a given incident angle θ1.

In this regard, according to various embodiments, the ratio S of the ellipses 232, defined as the ratio of the major radius R1 to the minor radius R2, is configured to closely match or resemble the ratio Q of the beam spot 410, defined as the ratio of the major radius D1 and the minor radius D2 for a given optical fiber 400 at a given incident angle θ1. In some embodiments, the ratio S is substantially equal to the ratio Q. In some embodiments, the major radius R1 and the minor radius R2 of the grating lines 230 are configured such that a difference between the ratio S and the ratio Q is within ± 5% numerically.

In some embodiments, the value of the ratio S increases as the incident angle θ1 increases. To obtain values (or ranges of values) of the ratio S based on a given incident angle θ1, the ratio Q corresponding to the incident angle θ1 is first determined (e.g., empirically) based on the correlation defined herein. The ratio Q may then be used to determine the ratio S as described above. For embodiments in which the incident angle θ1 ranges from about 0° to about 15°, the ratio S may range from about 1 to about 2.6. Specifically, for embodiments in which the incident angle θ1 ranges from about 5° to about 15°, the ratio S ranges from about 1.5 to about 2.6.

In some examples, the correlation between the incident angle θ1 and the ratio S of the grating lines 230 may be determined empirically or by direct measurement. For example, the dimensions of the beam spot 410 can be directly measured at a given incident angle θ1. In some embodiments, the ratio S for each of the grating lines 230 of a grating coupler 224 remains substantially constant within the concentric .

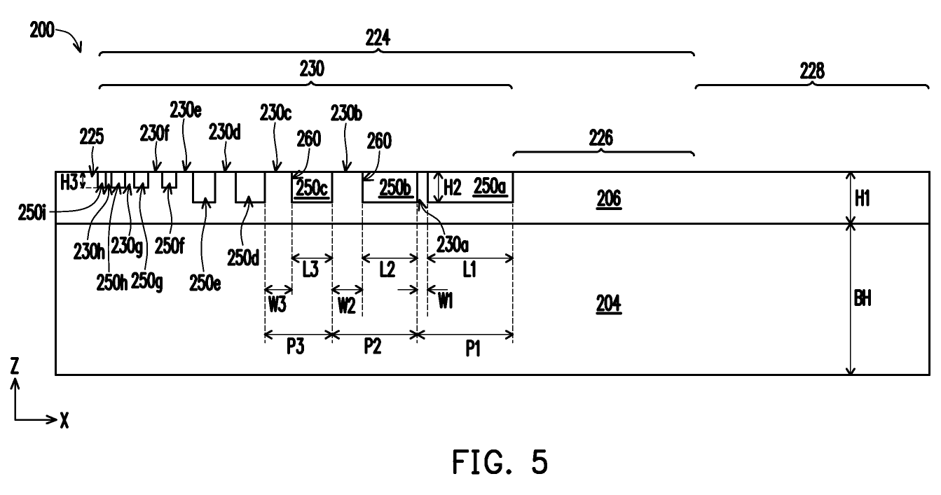

FIG. 5 depicts a cross-sectional view of an embodiment of the photonic die 200, or a portion thereof, taken along the line AA’ of FIG. 2. As shown, the grating lines 230a-230h are defined (or separated) by recesses 250a, 250b, 250c, 250d, 250e, 250f, 250g, 250h, and 250i (collectively referred to as recesses 250 hereafter) into the semiconductor layer 206. For example, the grating line 230a is separated from the tapered structure 226 by the recess 250a; the grating line 230b is separated from the grating line 230a by the recess 250b; the grating line 230c is separated from the grating line 230b by the recess 250c; the grating line 230d is separated from the grating line 230c by the recess 250d; the grating line 230e is separated from the grating line 230d by the recess 250e; the grating line 230f is separated from the grating line 230e by the recess 250f; the grating line 230g is separated from the grating line 230f by the recess 250g; the grating line 230h is separated from the grating line 230g by the recess 250h; and the grating line 230h is separated from an edge portion 225 of the semiconductor layer 206 by the recess 250i, where the edge portion 225 is opposite to the tapered structure 226 along the first lateral direction.

In the present embodiments, structures of the grating lines 230 and the corresponding recesses 250 may be defined by various shapes and dimensions and may vary within the grating coupler 224. In some instances, depending on factors such as the peak loss and bandwidth (e.g., narrow bandwidth or wide bandwidth) of the grating coupler, the shapes and the dimensions of the grating lines 230 may be adjusted accordingly.

In some embodiments, referring to FIG. 5, the dielectric layer 204 has a thickness BH, and the semiconductor layer 206 has a thickness H1 that is less than the thickness BH. In some non-limiting examples, the thickness H1 may be about 200 nm to about 500 nm, such as at least about 270 nm and less than about 500 nm. In some non-limiting examples, the thickness BH may be a non-zero value that is less than about 3 µm, such as at least about 2 µm.

In some embodiments, still referring to FIG. 5, depths of the recesses 250 vary along the first lateral direction, where the depths each extend along a vertical direction (e.g., the Z axis). For example, the recesses 250a-250e may each have a depth H2, while the recesses 250f-250i may each have a depth H3 that is less than the depth H2. As provided herein, the depths H2 and H3 are both less than the thickness H1 such that the recesses 250 do not penetrate through the semiconductor layer 206. The depths H2 and H3 may be alternatively considered as heights of the grating lines 230.

The various depths of the recesses 250 may be achieved by varying parameters of an etching process used to pattern the semiconductor layer 206 to form the grating lines 230. For example, the various depths are achieved by changing the duration of the etching process applied to different portions of the semiconductor layer 206 that correspond to positions of the different recesses 250. In this regard, the recesses 250a-250e with a greater depth (e.g., the depth H2) are etched for a longer duration than the recesses 250f-250i with a shallower depth (e.g., the depth H3). In some non-limiting examples, the depths H2 and H3 may each be about 70 nm to about 210nm. In some non-limiting examples, the depth H2 may be at least about 200 nm and the depth H3 may be at least about 100 nm. Though not depicted herein, two adjacent recesses 250 may be configured with different depths. For example, the recess 250a has the depth H2 and the recess 250b has the depth H3.

In some embodiments, widths of the recesses 250 may vary along the first lateral direction, where the widths each extend along the first lateral direction. For instance, the recess 250a has a width L1, the recess 250b has a width L2, and the recess 250c has a width L3, where the width L1 is greater than the width L2, which is greater than the width L3. The widths L1, l2, and L3 may be alternatively considered as spacings between adjacent grating lines 230. Though not described in detail herein, the additional recesses 250d-250i may also have varying widths along the first lateral direction.

In some embodiments, still referring to FIG. 5, widths of the grating lines 230 also vary along the first lateral direction, where the widths each extend along the first lateral direction. For example, the grating line 230a has a width W1, the grating line 230b has a width W2, and the grating line 230c has a width W3, where the width W1 is less than the width W2, which is greater than the width W3. Though not described in detail herein, the additional grating lines 230d-230h may also have varying widths along the first lateral direction.

In some non-limiting examples, the widths W1, W2, and W3 may each be about 10 nm to about 600 nm. In some non-limiting examples, a pitch Pn (e.g., P1, P2, P3, etc.) of each grating line 230, which defined as a sum of a width Wn (e.g., W1, W2, W3, etc.) of each grating line 230 and a width Ln (e.g., L1, L2, L3, etc.) of each recess 250 adjacent to the grating line 230, may also vary along the first lateral direction. In the depicted embodiments, for example, P1 is a sum of the width W1 and the width L1; P2 is a sum of the width W2 and the width L2; and P3 is a sum of the width W3 and the width L3. In some non-limiting examples, the pitch Pn is less than about 600 nm for an incident light having a wavelength of about 1310 nm.

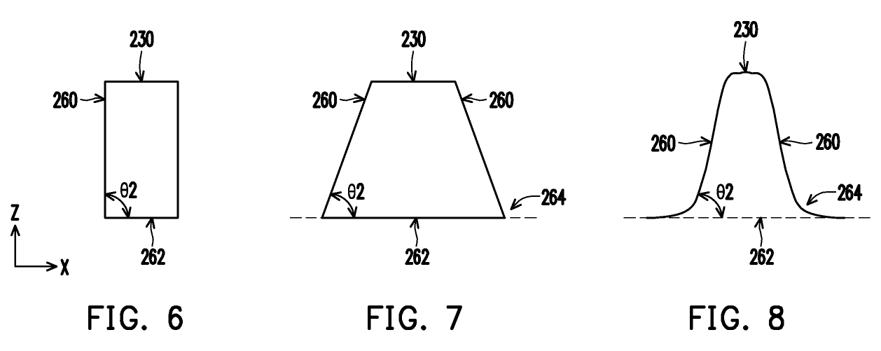

In addition, the grating line 230 may include various profiles. For example, referring to FIGS. 6, 7, and 8, which each illustrate an example embodiment of a cross-sectional view of a grating line 230, each sidewall 260 of the grating line 230 forms a non-zero angle θ2 with a horizontal surface 262 of the grating coupler 224, where the horizontal surface 262 is parallel to a top surface of the semiconductor substrate 212 (not shown). In some embodiments, referring to FIG. 6, the sidewall 260 is substantially perpendicular to the horizontal surface 262 such that the angle θ2 is about 90°. In some embodiments, referring to FIGS. 7 and 8, top portions of the opposing sidewalls 260 are slanted towards one another such that the angle θ2 is an acute angle (i.e., less than about 90°). In some non-limiting examples, the angle θ2 may be about 60° to about 90°, such as at least about 85° and less than about 90°. In some embodiments, referring to FIG. 7, a bottom portion 264 of the sidewall 260 has an angled (or sharp) profile. Alternatively, referring to FIG. 8, the bottom portion 264 has a rounded (or smooth) profile.

It is noted that the present disclosure does not limit the various dimensions (e.g., the depths H2 and H3, the widths Wn, and the width Ln, etc.) of the grating lines 230 and the recesses 250 described above to any particular values, nor to any particular patterns of variation. In fact, according to some embodiments of the present disclosure, these dimensions may be intentionally randomized to reduce optical reflection (e.g., optical noise) of the incident light off the grating coupler 224, thereby improving the coupling efficiency of the photonic die 200. For example, the widths Wn may first decrease and then increase, while the widths Ln may continuously decrease, from the grating line 230a to the grating line 230h along the first lateral direction. While the aforementioned dimensions of the grating lines 230 are not limited to any specific values, a grating coupler, such as the grating coupler 224, configured with dimensions within the numeric ranges described herein may exhibit enhanced device performance in terms of peak loss of the photonic die 200, for example.

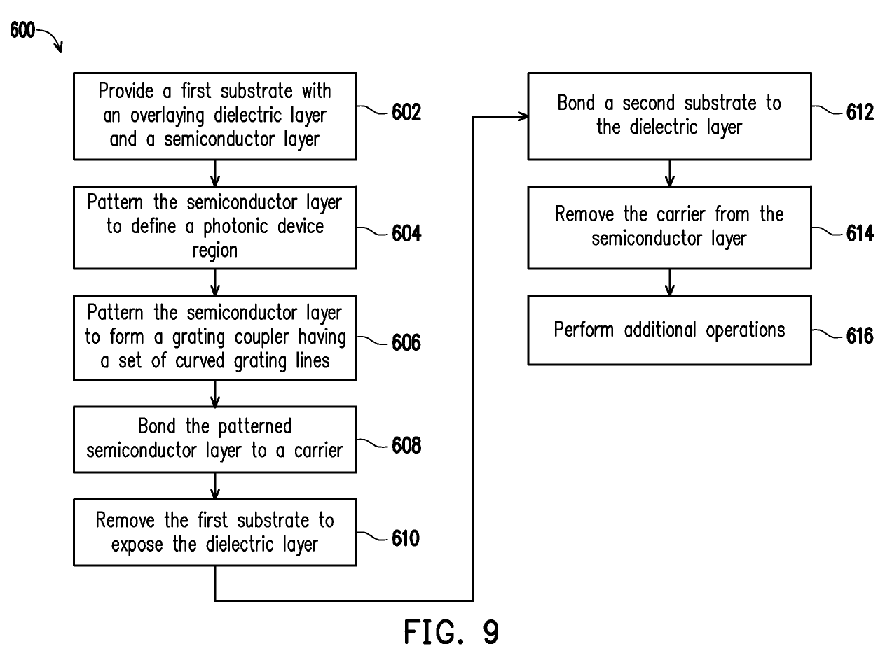

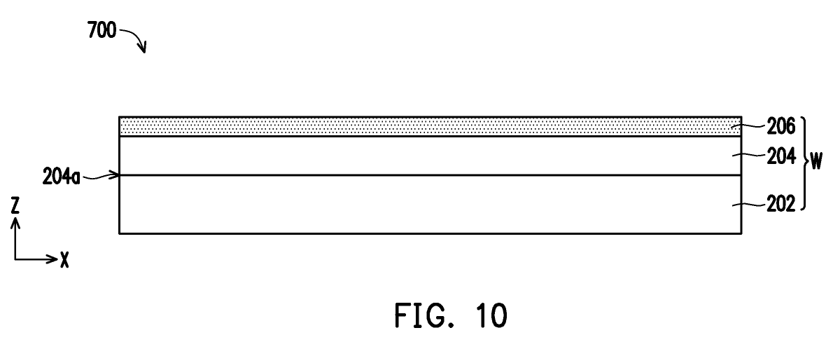

FIG. 9 illustrates a flowchart of a method 600 to form a semiconductor structure 700, which may include (or provide) the photonic die 200, according to one or more embodiments of the present disclosure. It is noted that the method 600 is merely an example, and is not intended to limit the present disclosure. Accordingly, it is understood that additional operations may be provided before, during, and after the method 600 of FIG. 9, and that some other operations may only be briefly described herein. In some embodiments, operations of the method 600 may be associated with cross-sectional views of the semiconductor structure 700 at various fabrication stages as shown in FIGS. 10-21, which will be discussed in further detail below.

Referring to FIG. 10, the method 600 at operation 602 provides a semiconductor wafer W including a semiconductor substrate 202 (or semiconductor layer), the dielectric layer 204 disposed on the semiconductor substrate 202, and the semiconductor layer 206 disposed on the dielectric layer 204. The semiconductor wafer W may be a silicon-on-insulator (SOI) wafer including a silicon substrate (e.g., the semiconductor substrate 202), a silicon dioxide (SiO₂) layer (e.g., the dielectric layer 204) disposed on the silicon substrate, and a silicon layer (e.g., the semiconductor layer 206) disposed on the silicon dioxide layer, where the silicon layer may be a doped layer. The dielectric layer 204 may entirely cover a top surface (or a frontside) of the semiconductor substrate 202. The semiconductor layer 206 may entirely cover a top surface of the dielectric layer 204. A thickness of the semiconductor substrate 202 may range from about 50 µm to about 760 µm, a thickness of the dielectric layer 204 may range from about 0.5 µm to about 5 µm, and a thickness of the semiconductor layer 206 may range from about 100 nm to about 5 µm. For example, the thickness of the semiconductor substrate 202 may be about 100 µm, the thickness of the dielectric layer 204 may be about 2 µm, and the thickness of the semiconductor layer 206 may be about 270 nm. The semiconductor wafer W may include other types of semiconductor material(s) and dielectric material(s) arranged in a configuration as described herein.

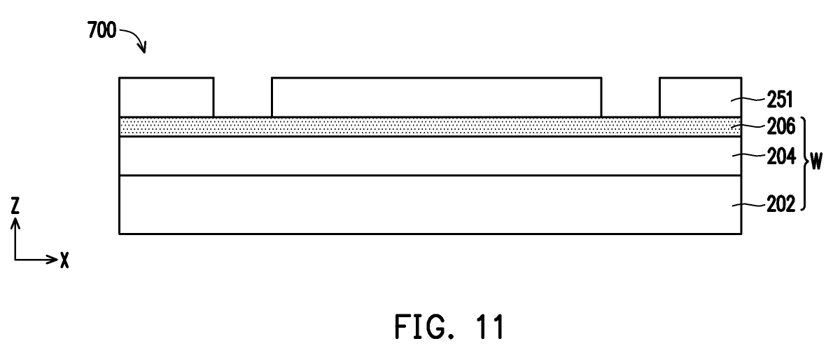

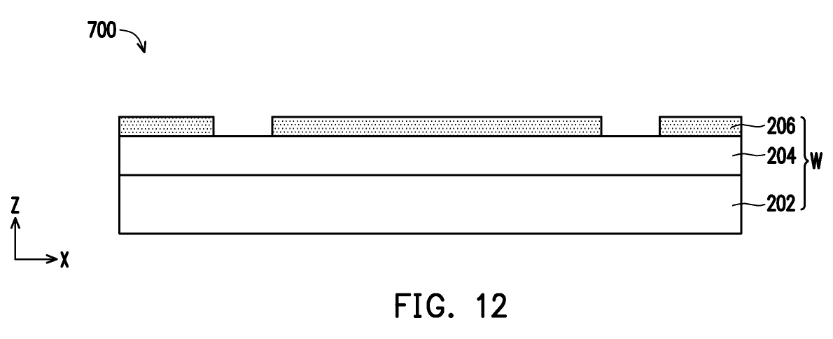

Referring to FIGS. 11 and 12, the method 600 at operation 604 patterns the semiconductor layer 206 to define a photonic device region of the semiconductor structure 700. Referring to FIG. 11, a patterned photoresist layer 251 is formed over the semiconductor wafer W to cover portions of the semiconductor layer 206. The semiconductor layer 206 may include the photonic device region covered by the patterned photoresist layer 251. In some embodiments, the semiconductor layer 206 further includes an electric device region for forming semiconductor devices (not shown), such as metal-oxide-semiconductor field effect transistors (MOSFETs), capacitors, inductors, resistors, the like, or combinations thereof. The patterned photoresist layer 251 may be formed on the semiconductor layer 206 through a photolithography process, which may include spin coating of photoresist material, baking of the photoresist material, exposure of the baked photoresist material and development of the exposed photoresist material.

Referring to FIG. 12, a patterning process is performed to remove portions of the semiconductor layer 206 that are exposed by the patterned photoresist layer 251 such that the semiconductor layer 206 is formed over the dielectric layer 204. The patterning process of the semiconductor layer 206 may include an etching process, such as a dry etching process, a reactive ion etching (RIE) process, a wet etching process, the like or combinations thereof, for removing the portions of the semiconductor layer 206 until portions of the dielectric layer 204 are revealed. After performing the patterning process, the patterned photoresist layer 251 is removed from the semiconductor layer 206 by any suitable process, such as plasma ashing, resist stripping, or the like.

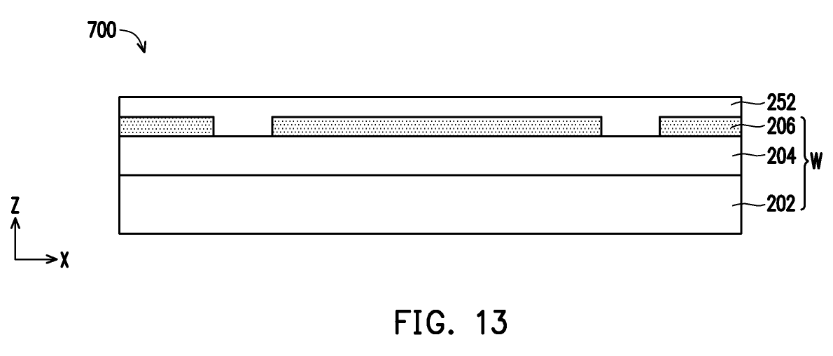

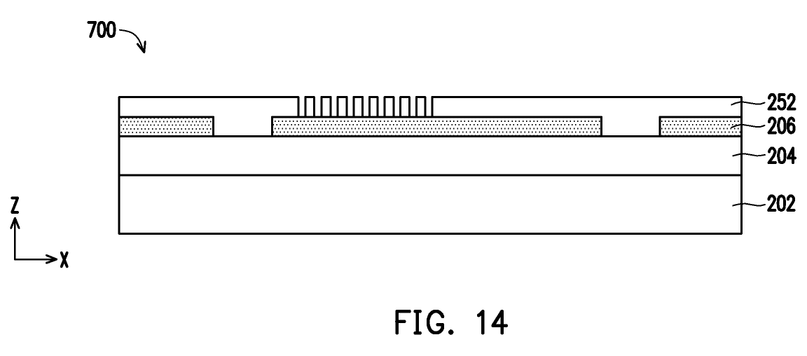

Referring to FIGS. 13-15, the method 600 at operation 606 further patterns the semiconductor layer 206 to form the grating coupler 224, which includes the grating lines 230 and the tapered structure 226, and the waveguide 228. Referring to FIGS. 13 and 14, a patterned photoresist layer 252 is formed to cover the semiconductor layer 206 and the dielectric layer 204. The patterned photoresist layer 252 may be formed on the semiconductor layer 206 and the dielectric layer 204 through the photolithography process as provided herein.

In the present embodiments, the patterned photoresist layer 252 includes slit patterns corresponding to the geometry of the set of grating lines 230 of the grating coupler 224. In one example, the slit patterns defined in the patterned photoresist layer 252 may correspond to an embodiment of an arrangement of the grating lines 230 as depicted in FIG. 2. In another example, the slit patterns defined in the patterned photoresist layer 252 may correspond to an embodiment of an arrangement of the grating lines 230 as depicted in FIG. 3. In yet another example, the slit patterns defined in the patterned photoresist layer 252 may correspond to an embodiment of an arrangement of the grating lines 230 as depicted in FIG. 5. In particular, the shape, position, and/or dimension of the grating lines 230 correspond to the shape, position, and/or dimension of the slits to be formed in the semiconductor layer 206 by the subsequently patterning process.

Referring to FIG. 14, a patterning process is performed to remove portions of the semiconductor layer 206 that are exposed by the patterned photoresist layer 252 such that the semiconductor layer 206 including the grating coupler 224 and the waveguide 228 is formed over a top surface of the dielectric layer 204, where the grating coupler 224 includes the set of grating lines 230 and the tapered structure 226 extending from the set of grating lines 230 towards the waveguide 228. The patterning process may include an etching process for removing portions of the semiconductor layer 206 that are exposed by the patterned photoresist layer 252. The etching depth of the removal process may be less than the thickness H1 of the semiconductor layer 206. In the present embodiments, the etching depth of the patterning process may correspond to the depths H2 and H3, for example, which may be about 70 nm to about 210 nm as described herein (see FIG. 5). In some embodiments, the patterning process may include multiple etching processes, such as a dry etching process, a reactive ion etching (RIE) process, a wet etching process, the like, or combinations thereof.

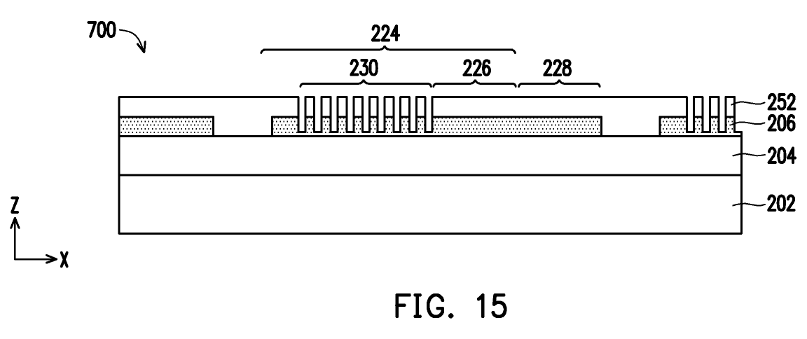

After performing the patterning process, the grating coupler 224 and the waveguide 228 are formed in connection with one another along the first lateral direction over a portion of the semiconductor layer 206 that overlaps with the dielectric layer 204. Referring to FIG. 15, after performing the patterning process, the patterned photoresist layer 252 is removed from the semiconductor layer 206 and the dielectric layer 204 by any suitable process provided herein.

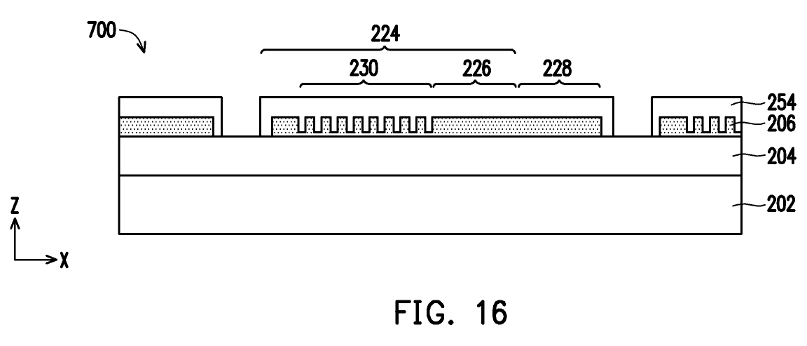

Referring to FIG. 16, a patterned photoresist layer 254 may be then formed to cover the semiconductor layer 206 and portions of the dielectric layer 204 through the photolithography process provided herein. In some embodiments, the semiconductor layer 206 is entirely covered by the patterned photoresist layer 254.

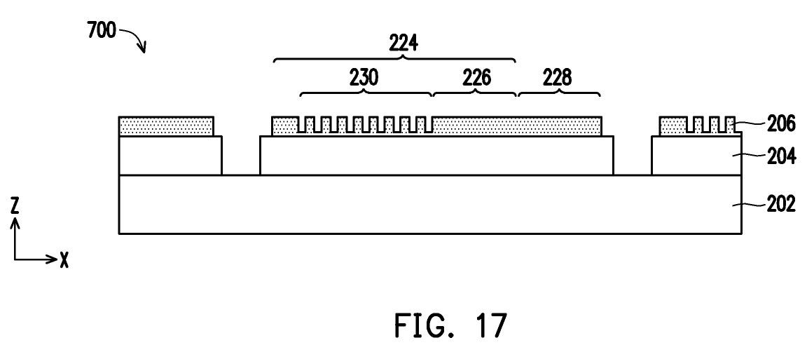

Referring to FIG. 17, a patterning process is performed to remove portions of the dielectric layer 204 that are exposed by the patterned photoresist layer 254, resulting in the dielectric layer 204 to have a predetermined pattern over the semiconductor substrate 202. The patterning process may include an etching process for removing the portions of the dielectric layer 204 until portions of the semiconductor substrate 202 are revealed. After performing the patterning process, the patterned photoresist layer 254 is removed from the semiconductor layer 206 and the dielectric layer 204 by any suitable process provided herein. In some embodiments, the patterning process for removing portions of the dielectric layer 204 is omitted.

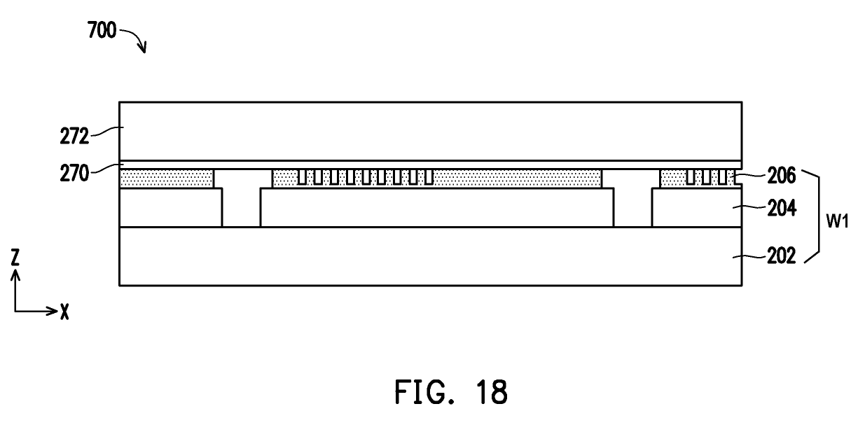

Referring to FIG. 18, the method 600 at operation 608 bonds the semiconductor structure 700 to a carrier 272 (alternatively referred to as a carrier wafer, a handle wafer, etc.) using an adhesive layer 270 formed over the carrier 272. The carrier 272 may include a glass carrier, and the adhesive layer 270 may be a light-to-heat conversion (or light transfer heat conversion, or LTHC) layer adhered to a surface of the carrier 272. The resulting semiconductor wafer W1 includes the semiconductor substrate 202, the dielectric layer 204, and the semiconductor layer 206, which is temporarily bonded to the carrier 272 through the adhesive layer 270. After the semiconductor wafer W1 is temporarily bonded with the carrier 272, the semiconductor layer 206 is in contact with the adhesive layer 270. In other words, the carrier 272 and the semiconductor wafer W1 are located at opposite sides of the adhesive layer 270.

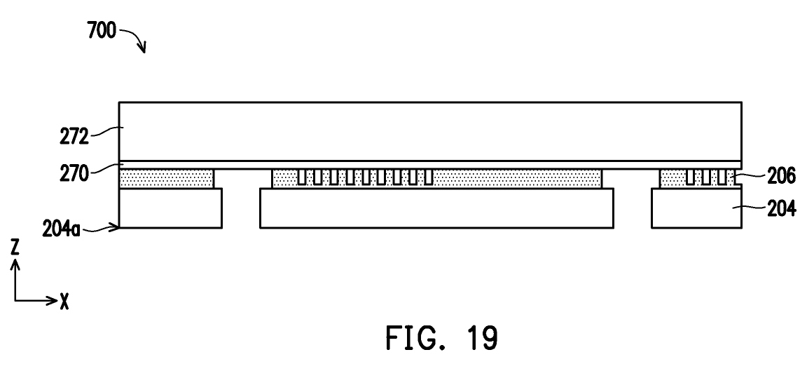

Referring to FIG. 19, the method 600 at operation 610 removes the semiconductor substrate 202 from a backside 204a (or a bottom surface) of the dielectric layer 204 such that a frontside (or a top surface) of the semiconductor structure 700 is temporarily carried by the carrier 272, and the backside of the dielectric layer 204 is revealed. In some embodiments, the semiconductor substrate 202 is removed from the dielectric layer 204 through a laser lift-off process, a backside etching process, a grinding process, or the like. The grinding process may include a mechanical grinding process, a chemical-mechanical polishing (CMP) process, the like, or combinations thereof.

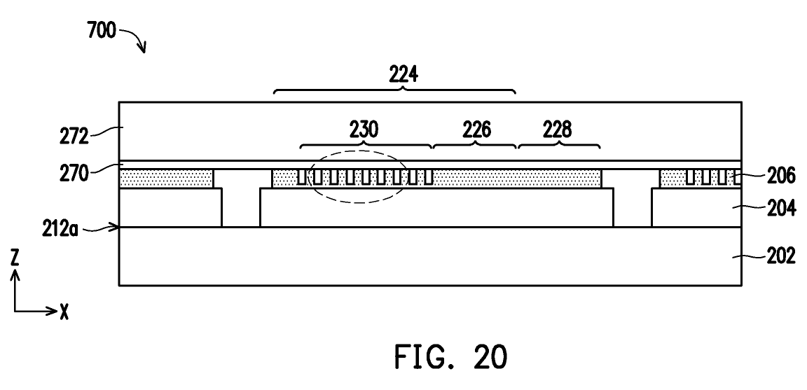

Referring to FIG. 20, the method 600 at operation 612 bonds a frontside 212a (or top surface) of the semiconductor substrate 212 (or semiconductor layer) to the backside of the dielectric layer 204. In some embodiments, the frontside of the semiconductor substrate 212 is bonded to the backside of the dielectric layer 204 through a wafer-to-wafer fusion bonding process, a hybrid bonding process, or the like. The bonding temperature of the wafer-to-wafer fusion bonding process may range from about 200° C to about 600° C.

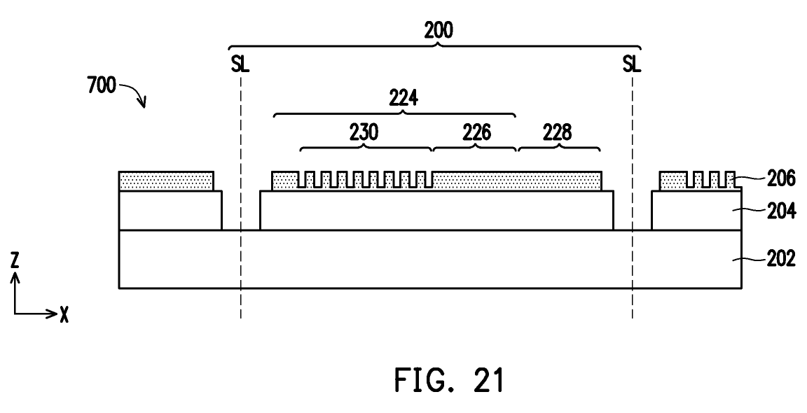

Referring to FIG. 21, the method 600 at operation 614 performs a de-bonding process to remove the carrier 272 and the adhesive layer 270 from the semiconductor structure 700. The carrier 272 and the adhesive layer 270 may be de-bonded from the semiconductor layer 206 by irradiating the semiconductor structure 700 with laser, which heats and subsequently releases the adhesive layer 270 and the carrier 272 from the semiconductor layer 206. In various embodiments of the present disclosure, the operations 608 to 614 described herein are optional and may be omitted for the fabrication of the semiconductor structure 700.

The method 600 at operation 616 may perform additional operations. For example, still referring to FIG. 21, the semiconductor structure 700 may be singulated along scribe lines SL to obtain the photonic die 200, which includes the semiconductor substrate 212, the dielectric layer 204 over the semiconductor substrate 212, and semiconductor layer 206 over the dielectric layer 204, as depicted in FIG. 3. The semiconductor layer 206 includes the grating coupler 224 connected (or coupled) to the waveguide 228. In the present embodiments, the grating coupler 224 includes the set of grating lines 230 as depicted in FIGS. 2, 3, and/or 5. The photonic die 200 may be further packaged, integrated with other dies (e.g., electric dies, photonic dies, etc.), or otherwise processed to form a semiconductor device.

In one aspect, the present disclosure provides a semiconductor structure. The semiconductor structure includes a semiconductor layer. The semiconductor structure includes a grating coupler disposed on the semiconductor layer. The semiconductor structure further includes a waveguide disposed on the semiconductor layer and adjacent to the grating coupler along a lateral direction. The grating coupler includes a plurality of grating lines. Each of the grating lines extends along a curve that conforms to a segment of an ellipse, where the ellipse is defined by a radius R1 and a radius R2 that is less than the radius R1.

In another aspect, the present disclosure provides a photonic die. The photonic die includes a substrate. The photonic die further includes a device layer disposed over the substrate. The device layer includes a grating coupler and a waveguide adjacent to the grating coupler. The grating coupler includes a plurality of grating lines arranged in a concentric pattern on the device layer along a lateral direction. Each of the grating lines extends along a segment of an ellipse, where the ellipse is defined by a major radius and a minor radius. A ratio of the major radius to the minor radius is greater than one.

In yet another aspect, the present disclosure provides a method that includes providing a first semiconductor layer over a dielectric layer, where the dielectric layer includes a bottom surface. The method includes forming a grating coupler and a waveguide in the first semiconductor layer. The grating coupler includes a plurality of curved grating lines spaced apart from one another in a lateral direction. Each of the curved grating lines extends along a segment of an ellipse, where the ellipse is defined by a first radius and a second radius that is different from the first radius. The method includes providing a second semiconductor layer having a second top surface. The method further includes bonding the bottom surface to the second top surface to form a semiconductor structure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor structure, comprising:
a semiconductor layer;
a grating coupler disposed on the semiconductor layer, the grating coupler including a plurality of grating lines, wherein each of the grating lines extends along a curve that conforms to a segment of an ellipse, the ellipse defined by a radius R1 and a radius R2 less than the radius R1; and
a waveguide disposed on the semiconductor layer and adjacent to the grating coupler along a lateral direction.

2. The semiconductor structure of claim 1, wherein the grating lines are spaced apart from one another along the lateral direction.

3. The semiconductor structure of claim 1, wherein the grating lines are arranged in a concentric pattern.

4. The semiconductor structure of claim 1, wherein:
the grating coupler includes a first grating line and a second grating line,
the first grating line has a first width along the lateral direction,
the second grating line has a second width along the lateral direction, and
the second width is different from the first width.

5. The semiconductor structure of claim 4, wherein:
the grating coupler further includes a third grating line,
the first grating line and the second grating line are separated by a first recess having a third width along the lateral direction,
the second grating line and the third grating line are separated by a second recess having a fourth width along the lateral direction, and
the third width is different from the fourth width.

6. The semiconductor structure of claim 5, wherein:
the first recess has a first depth along a vertical direction perpendicular to the lateral direction,
the second recess has a second depth along the vertical direction, and
the first depth is different from the second depth.

7. The semiconductor structure of claim 1, wherein a sidewall of each of the grating lines includes a bottom portion that has a rounded profile.

8. The semiconductor structure of claim 1, wherein a sidewall of each of the grating lines is slanted with respect to a top surface of the semiconductor layer.

9. A die, comprising:
a substrate; and
a device layer disposed over the substrate, the device layer including:
a grating coupler having a plurality of grating lines arranged in a concentric pattern on the device layer along a lateral direction, wherein each of the grating lines extends along a segment of an ellipse, the ellipse defined by a major radius and a minor radius, and a ratio of the major radius to the minor radius greater than one, and
a waveguide adjacent to the grating coupler.

10. The die of claim 9, further comprising a dielectric layer disposed between the substrate and the device layer.

11. The die of claim 9, wherein:
the grating coupler includes a tapered structure, and
the tapered structure is disposed adjacent to the waveguide along the lateral direction.

12. The die of claim 9, wherein a sidewall of each of the grating lines includes a bottom portion that has a rounded profile.

13. The die of claim 9, wherein spacings between two adjacent grating lines vary along the lateral direction, each of the spacings extending along the lateral direction.

14. The die of claim 9, wherein widths of the grating lines vary along the lateral direction, each of the widths extending along the lateral direction.

15. The die of claim 9, wherein heights of the grating lines vary along the lateral direction, each of the heights extending along a vertical direction perpendicular to the lateral direction.

16. A method, comprising:
providing a first semiconductor layer over a dielectric layer, the dielectric layer having a bottom surface;
forming a grating coupler and a waveguide in the first semiconductor layer, the grating coupler including a plurality of curved grating lines spaced apart from one another in a lateral direction, wherein each of the curved grating lines extends along a segment of an ellipse, the ellipse defined by a first radius and a second radius different from the first radius;
providing a second semiconductor layer having a top surface; and
bonding the bottom surface to the top surface to form a semiconductor structure.

17. The method of claim 16, wherein forming the grating coupler includes etching the first semiconductor layer to form the curved grating lines.

18. The method of claim 16, wherein forming the grating coupler includes forming a plurality of recesses each interposed between two adjacent curved grating lines, and wherein depths of the recesses vary along the lateral direction.

19. The method of claim 16, wherein the dielectric layer is provided on a third semiconductor layer, the method further comprising:
bonding the first semiconductor layer having the grating coupler to a carrier before bonding the bottom surface to the top surface; and
removing the third semiconductor layer to expose the bottom surface of the dielectric layer.

20. The method of claim 16, further comprising singulating the semiconductor structure to form a photonic die that includes the grating coupler and the waveguide.
